(19) United States
(12) Patent Application Publication
(10) Pub. No.: US 2022/0414168 A1
(43) Pub. Date: Dec. 29, 2022

(54) SEMANTICS BASED SEARCH RESULT OPTIMIZATION

(71) Applicant: KYNDRYL, INC., NEW YORK, NY (US)

(72) Inventors: Edson Gomes Pereira, Cotia (BR); Luis Fernando Dias Batista, Itapira (BR); Thais Ferraz Gobato, Campinas (BR); Victor Hugo Marco Antonio, Sumare (BR)

(21) Appl. No.: 17/356,581

(22) Filed: Jun. 24, 2021

(51) Int. Cl. G06F 16/957; G06F 16/9035; G06F 40/247; G06F 16/955; G06N 20/00

(52) U.S. Cl. CPC G06F 16/957; G06F 16/9035; G06F 40/247; G06F 16/9566; G06N 20/00

(57) ABSTRACT

A computer-implemented method for generating optimized search results is disclosed. The computer-implemented method includes receiving a search input from a user, wherein the search input includes a search query and additional search criteria. The computer-implemented method further includes generating a search query pattern based, at least in part, on the search input. The computer-implemented method further includes determining an initial set of search results based on the search query pattern. The computer-implemented method further includes filtering the initial set of search results to determine a filtered subset of search results from the initial set of search results.

### BACKGROUND

The present invention relates generally to the field of search queries, and more particularly to optimizing search query results based on semantics.

A search query is a query based on specific search terms a user enters into a search engine. Generally, web search results present search query results as URLs to the user. These URLs are determined by mechanisms known as bots, crawling, and indexing. Crawling is the process of searching for content and looking for code or content for each URL found. The content located can be, for example, a webpage, image, video, or PDF, but every piece of content includes a corresponding URL link. Indexing is the process of storing and organizing the content found during the crawling process and is a candidate to be displayed as a search query result. Some search engines rank their index's for highly relevant content and then order the content in an attempt to solve the search query.

### SUMMARY

According to one embodiment of the present invention, a computer-implemented method for generating optimized search results is disclosed. The computer-implemented method includes receiving a search input from a user, wherein the search input includes a search query and additional search criteria. The computer-implemented method further includes generating a search query pattern based, at least in part, on the search input. The computer-implemented method further includes determining an initial set of search results based on the search query pattern. The computer-implemented method further includes filtering the initial set of search results to determine a filtered subset of search results from the initial set of search results.

According to another embodiment of the present invention, a computer program product for generating optimized search results is disclosed. The computer program product includes one or more computer readable storage media and program instructions stored on the one or more computer readable storage media. The program instructions include instructions to receive a search input from a user, wherein the search input includes a search query and additional search criteria. The program instructions further include instructions to generate a search query pattern based, at least in part, on the search input. The program instructions further include instructions to determine an initial set of search results based on the search query pattern. The program instructions further include instructions to filter the initial set of search results to determine a filtered subset of search results from the initial set of search results.

According to another embodiment of the present invention, a computer system for generating optimized search results is disclosed. The computer system includes one or more computer processors, one or more computer readable storage media, and computer program instructions, the computer program instructions being stored on the one or more computer readable storage media for execution by the one or more computer processors. The program instructions include instructions to receive a search input from a user, wherein the search input includes a search query and additional search criteria. The program instructions further include instructions to generate a search query pattern based, at least in part, on the search input. The program instructions further include instructions to determine an initial set of search results based on the search query pattern. The program instructions further include instructions to filter the initial set of search results to determine a filtered subset of search results from the initial set of search results.

### BRIEF DESCRIPTION OF DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a functional block diagram of a network computing environment for optimizing search query results based on semantics, generally designated 100, in accordance with at least one embodiment of the present invention.

FIG. 2 is a flow chart diagram depicting operational steps for filtering a search query, generally designated 200, in accordance with at least one embodiment of the present invention.

FIG. 3 is a flow chart diagram depicting operational steps for updating an initial set of search results, generally designated 300, in accordance with at least one embodiment of the present invention.

FIG. 4 is a flow chart diagram depicting operational steps for generating a final set of search results the updated initial set of search results, generally designated 400, in accordance with at least one embodiment of the present invention

FIG. 5 is a flow chart diagram depicting operational steps for updating a machine learning model, generally designated 500, in accordance with at least one embodiment of the present invention.

FIG. 6 illustrates an exemplary query interface for entering a query and various additional information associated with the query, generally designated 600, in accordance with at least one embodiment of the present invention.

FIG. 7 illustrates an exemplary user dashboard for displaying search results and various additional information associated with the search results, generally designated 700, in accordance with at least one embodiment of the present invention.

FIG. 8 is a block diagram depicting components of a computing device, generally designated 800, suitable for operation of a search result optimizing program 101 in accordance with at least one embodiment of the invention.

FIG. 9 is a block diagram depicting a cloud computing environment 50 in accordance with at least one embodiment of the present invention.

FIG. 10 is block diagram depicting a set of functional abstraction model layers provided by cloud computing environment 50 depicted in FIG. 9 in accordance with at least one embodiment of the present invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

The present invention relates generally to the field of search queries, and more particularly to optimizing search query results based on semantics.

Currently, many search engines display search results as words without a more in depth analysis. Oftentimes, search results include thousands of non-relevant results and topics outside the topic area the user intended to search for. In many instances, some words or phrases have multiple uses or meanings. Words in a search query can pull up a large number of results and results in different topic areas. For example, a search query including the term “virus” may retrieve results for human viruses or computer viruses. Further, a search query including the term “virus” may retrieve results having various information on medicine to treat a virus, clinical trials against viruses, virus guidelines, patents related to a virus, the sale and purchase of anti-virus computer software, and so on. The variety of information that may be returned to a user causes the user to have to either manipulate their search query or comb through the search results themselves, either of which can be extremely time consuming on the users end.

Accordingly, embodiments of the present invention recognize the need to give users more options and relevant information to narrow and organize their search results. Embodiments of the present invention provide a more in-depth analysis of search results beyond merely presenting a user with a list of websites or URLs. Embodiments of the present invention use machine learning to evaluate the semantics of a user search query. Embodiments of the present invention enable the user to generate search queries based on particular topics of interest. Embodiments of the present invention determine and identify key points from the search query and determine relationships and keywords thereof. Embodiments of the present invention categorize these relationships and keywords into categories and suggest new search themes for the user from particular knowledge areas of interest.

Embodiments of the present invention determine the most relevant content by searching the word or phrase described by the user, organizing the content, removing advertisements and non-related links, categorizing and establishing relationships with predetermined knowledge areas of interest, using synonym verification and word count to rank the results, and user feedback and machine learning to identify positive answers. Embodiments of the present invention further use user centric ranking based on the user preferences instead of paid for ads.

The present invention may be a system, a method, and/or a computer program product at any possible technical detail level of integration. The computer program product may include a computer readable storage medium (or media) having computer readable program instructions thereon for causing a processor to carry out aspects of the present.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suit-able combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

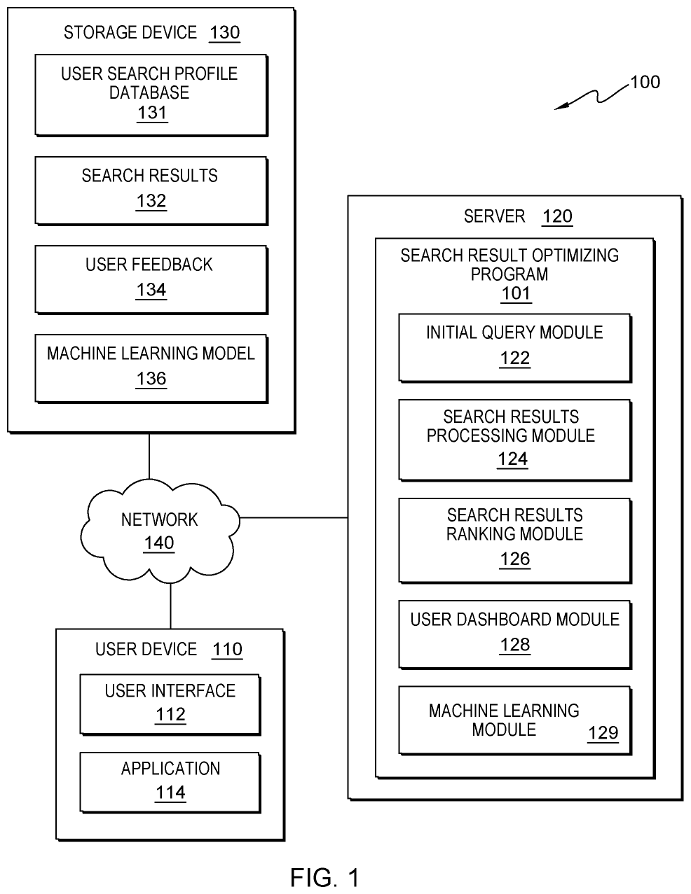

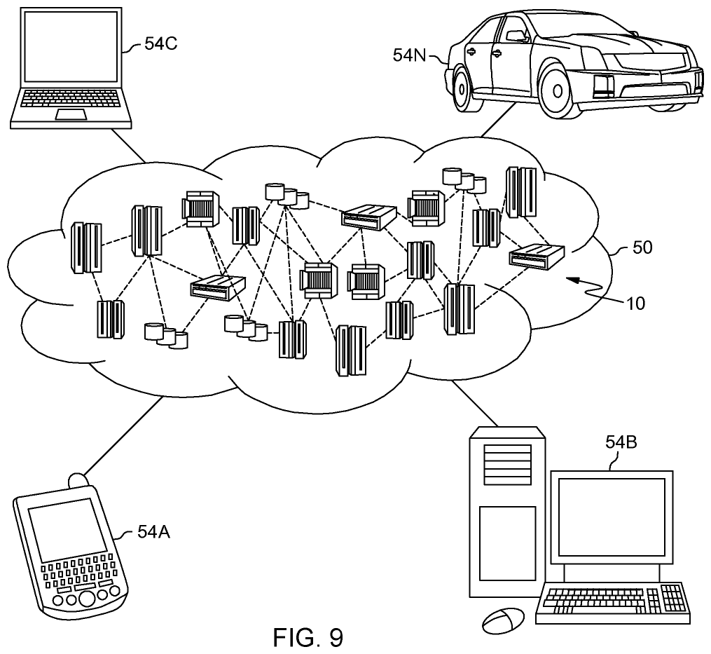

The present invention will now be described in detail with reference to the Figures. FIG. 1 is a functional block diagram of a network computing environment for optimizing search query results based on semantics, generally designated 100, in accordance with at least one embodiment of the present invention. In an embodiment, network computing environment 100 may be provided by cloud computing environment 50, as depicted and described with reference to FIG. 9, in accordance with at least one embodiment of the present invention. FIG. 1 provides an illustration of only one implementation and does not imply any limitations with regard to the environments in which different embodiments may be implemented. Many modifications to the depicted environment may be made by those skilled in the art without departing from the scope of the present invention as recited by the claims.

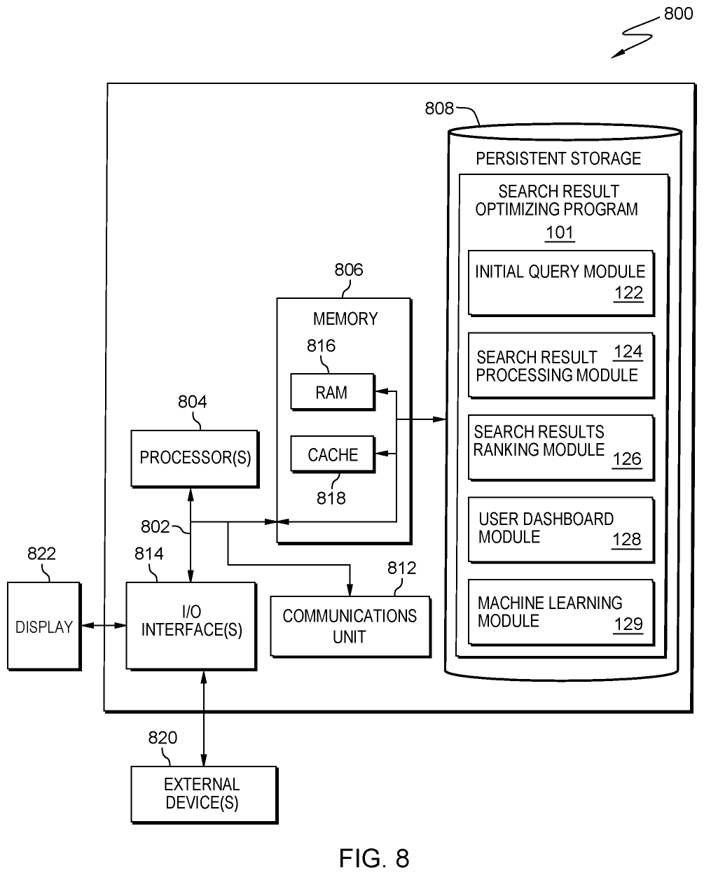

Network computing environment 100 includes user device 110, server 120, and storage device 130 interconnected over network 140. User device 110 may represent a computing device of a user, such as a laptop computer, a tablet computer, a netbook computer, a personal computer, a desktop computer, a personal digital assistant (PDA), a smart phone, a wearable device (e.g., smart glasses, smart watches, e-textiles, AR headsets, etc.), or any programmable computer systems known in the art. In general, user device 110 can represent any programmable electronic device or combination of programmable electronic devices capable of executing machine readable program instructions and communicating with server 120, storage device 130, and other devices (not depicted) via a network, such as network 140. User device 110 can include internal and external hardware components, as depicted and described in further detail with respect to FIG. 8.

User device 110 further includes user interface 112 and application 114. User interface 112 is a program that provides an interface between a user of an end user device, such as user device 110, and a plurality of applications that reside on the device (e.g., application 114). A user interface, such as user interface 112, refers to the information (such as graphic, text, and sound) that a program presents to a user, and the control sequences the user employs to control the program. A variety of types of user interfaces exist. In one embodiment, user interface 112 is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements. In another embodiment, user interface 112 is a script or application programming interface (API).

Application 114 can be representative of one or more applications (e.g., an application suite) that operate on user device 110. In an embodiment, application 114 is representative of one or more applications (e.g., social media applications, web conferencing applications, and email applications) located on user device 110. In various example embodiments, application 114 can be an application that a user of user device 110 utilizes to input a desired search query and review a refined, ranked list of search results. In an embodiment, application 114 can be a client-side application associated with a server-side application running on server 120 (e.g., a client-side application associated with search result optimization program 101). In an embodiment, application 114 can operate to perform processing steps of search result optimizing program 101 (i.e., application 114 can be representative of search result optimizing program 101 operating on user device 110).

Server 120 is configured to provide resources to various computing devices, such as user device 110. In various embodiments, server 120 is a computing device that can be a standalone device, a management server, a web server, an application server, a mobile device, or any other electronic device or computing system capable of receiving, sending, and processing data. In an embodiment, server 120 represents a server computing system utilizing multiple computers as a server system, such as in a cloud computing environment. In an embodiment, server 120 represents a computing system utilizing clustered computers and components (e.g. database server computer, application server computer, web server computer, webmail server computer, media server computer, etc.) that act as a single pool of seamless resources when accessed within network computing environment 100. In general, server 120 represents any programmable electronic device or combination of programmable electronic devices capable of executing machine readable program instructions and communicating with each other, as well as with user device 110, storage device 130, and other computing devices (not shown) within network computing environment 100 via a network, such as network 140.

Server 120 may include components as depicted and described in detail with respect to cloud computing node 10, as described in reference to FIG. 9, in accordance with at least one embodiment of the present invention. Server 120 may include components, as depicted and described in detail with respect to computing device 800 of FIG. 8, in accordance with at least one embodiment of the present invention.

Server 120 includes search result optimizing program 101, which further includes initial query module 122, results processing module 124, ranking module 126, user dashboard module 128, and machine learning module 129. In an embodiment, search result optimizing program 101 may be configured to access various data sources, such as user search profile database 131, that may include personal data, content, contextual data, or information that a user does not want to be processed. Personal data includes personally identifying information or sensitive personal information as well as user information, such as location tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. In an embodiment, search result optimizing program 101 enables the authorized and secure processing of personal data. In an embodiment, search result optimizing program 101 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. In an embodiment, search result optimizing program 101 provides information regarding personal data and the nature (e.g., type, scope, purpose, duration, etc.) of the processing. In an embodiment, search result optimizing program 101 provides a user with copies of stored personal data. In an embodiment, search result optimizing program 101 allows for the correction or completion of incorrect or incomplete personal data. In an embodiment, search result optimizing program 101 allows for the immediate deletion of personal data.

In an embodiment, search result optimizing program 101 provides the capability to analyze and model collected user data based, at least in part, on natural language processing (NPL) techniques and machine learning (ML) techniques, in order to optimize the relevancy of search results returned to a user.

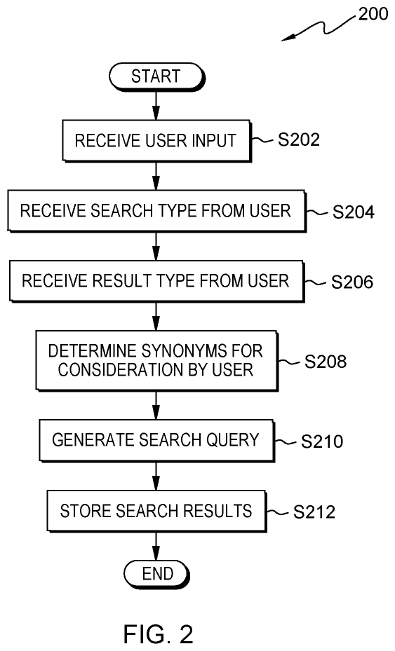

In an embodiment, search query module 122 is a component or sub-program of search result optimization program 101 that determines the intelligent arguments to search. In an embodiment, initial query module 122 takes the users initial query input and prompts the user for additional search criteria to narrow the query. Additional search criteria can include search type, result type, or synonyms from the initial query input. In an embodiment, initial query module 122 generates a search query pattern based, at least in part, on the user's search query input and additional search criteria. In an embodiment, initial query module 122 performs the flowchart steps described in further detail with respect to FIG. 2.

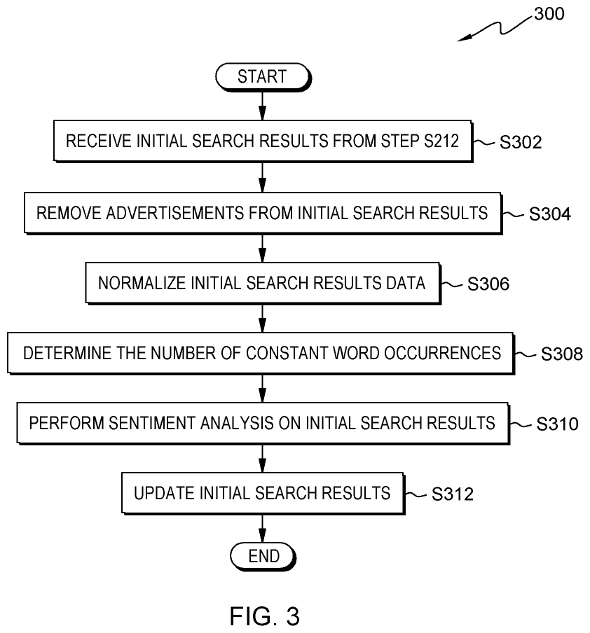

In an embodiment, search results processing module 124 is a component or sub-program of search result optimizing program 101 that processes the initial search results returned from the generated search query pattern. In an embodiment, search results processing module 124 updates the initial search results. In an embodiment, updating the initial search results includes removing advertisements from the initial search results. In an embodiment, updating the initial search results includes normalizing the initial search results data. In an embodiment, search results processing module 124 performs sentiment analysis on the initial search results. The initial search results may then be updated based on one or more sentiments associated with the initial set of search results. In an embodiment, search results processing module 124 performs the flowchart steps described in further detail with respect to FIG. 3.

In an embodiment, search results ranking module 126 is a component or sub-program of search result optimizing program 101 that ranks the search results. In an embodiment, search results ranking module 126 analyzes and evaluates the relevancy of search results returned with respect to one another. In an embodiment, search result ranking module 126 generates rankings based on those search results that have the most relevant topics with respect to the users search query input and additional search criteria. In an embodiment, search result ranking module 126 ranks the search results based, at least in part, on the additional search criteria entered by the user. In an embodiment, search result ranking module 126 ranks the search results based on applying the search results to machine learning model 136. For example, various information associated with search results are input into machine learning model 136 and given a ranking based on a comparison of the search results to a set of weighted factors associated with machine learning model 136. In an embodiment, the search results are ranked by a degree of relevance to the user's search query and any additional search criteria entered by the user. In an embodiment, the evaluation step may use a simple count how many of the search results correctly answer a query. However, it should be appreciated that any known types of scoring may be used.

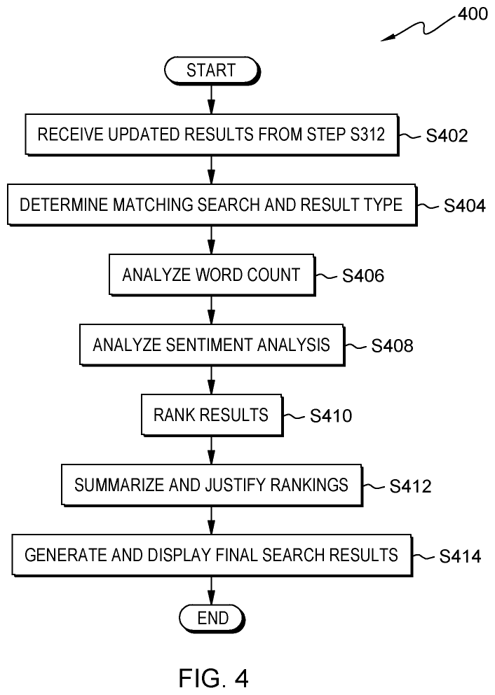

In an embodiment, user dashboard module 128 is a component or sub-program of search result optimizing program 101 that creates a user dashboard with the most relevant search results. In an embodiment, user dashboard module 128 organizes and displays the most relevant search to the user via a graphical user interface, such as user interface 112. In an embodiment, user dashboard module 128 performs the flowchart steps described in further detail with respect to FIG. 4.

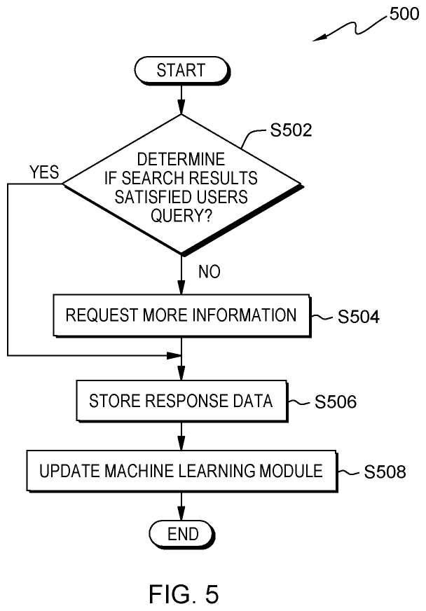

In an embodiment, machine learning module 129 is a component or sub-program of search result optimizing program 101 that performs machine learning. In an embodiment, machine learning module 129 collects and analyzes user feedback with respect to the ranked search results presented to the user. In an embodiment, machine learning module 129 determines if the user is satisfied with the search results. In an embodiment, machine learning module 129 trains and updates machine learning model 136 based on user feedback. In an embodiment, machine learning module 129 identifies or retrieves search results based on machine learning model 136. In an embodiment, machine learning module 129 performs the flowchart steps described in further detail with respect to FIG. 5.

In various embodiments, storage device 130 is a secure data repository for persistently storing search results, as well as user specific information used to conduct search queries. Storage device 130 may be implemented using any volatile or non-volatile storage media known in the art for storing data. For example, storage device 130 may be implemented with a tape library, optical library, one or more independent hard disk drives, multiple hard disk drives in a redundant array of independent disks (RAID), solid-state drives (SSD), random-access memory (RAM), and any, possible combination thereof. Similarly, storage device 130 may be implemented with any suitable storage architecture known in the art, such as a relational database, an object-oriented database, or one or more tables.

Storage device 130 includes a user search profile database 131, which further includes search results 132, user feedback 134, and machine learning model 136. Search results 132 includes the search results returned from a user search query. In an embodiment, search results 132 can include the initial search results and the filtered search results. In an embodiment, search results 132 includes information associated with the search type and result type. In an embodiment, search results 132 includes historical additional search criteria information entered by the user. User feedback 134 includes information associated with the feedback given by the user with respect to the relevancy of any search results presented to the user. For example, if the user indicates one or more search results were helpful or satisfactory, this information is stored in user feedback 134.

In an embodiment, machine learning model 136 is a file that has been trained to recognize certain types of patterns. In an embodiment, an initial machine learning model 136 is trained from various input data points gathered from user search profile database 131. In an embodiment, search result optimizing program 101 may utilize text to speech components, text to vector components, natural language processing, intention understanding, action prediction and results to refine machine learning model 136. In one embodiment, machine learning model 136 is designed to output suggested adjustment actions that enhance user engagement and facilitate greater consumption of presented information.

In an embodiment, machine learning model 136 is updated based on user feedback 134 to learn and improve the quality and relevancy of search results for a particular user over time. In an embodiment, machine learning model 136 is updated to refine search results presented to a user based on user feedback. In an embodiment, search results ranking module 126 ranks each of the search results based on one or more factors selected from the group consisting of user feedback, advertisements, word count, search type, or knowledge area. In an embodiment, machine learning module 129 assigns a weight to each factor associated with machine learning model 136, including user feedback, advertisements, word count, search type or knowledge area. In an embodiment, machine learning module 129 iteratively alters the weight assigned to each factor of machine learning model 136 based on user feedback. In an embodiment, the weights assigned to various factors of machine learning model 136 influence the impact that a particular factor has on returning and ranking particular search results. For example, a weight of 0.8 assigned to a knowledge area component of machine learning model 136 will be twice as influential in the particular search results returned than a weight of 0.4 assigned to a word count component of machine learning model 136.

Search result optimizing program 101 stores and retrieves various data to/from user search profile database 131, including, but not limited, to filtered search results and user feedback. For example, search result optimizing program 101 stores information including user feedback 134 in user search profile database 131. Search result optimizing program 101 retrieves user feedback 134 information from user search profile database 131 to determine whether or not the search results are satisfactory to the user. In an embodiment, search result optimizing program 101 retrieves search results 132 returned from previous search queries. In an embodiment, search result optimizing program 101 retrieves word count data associated with search results 132 returned from previous search queries from user search profile database 131. In an embodiment, search result optimizing program 101 retrieves sentiment information associated with the search results 132 returned from search queries from user search profile database 131. In an embodiment, search result optimizing program 101 stores and retrieves updated search results, refined search results, and ranked search results associated with search queries from user search profile database 131.

In an embodiment, search result optimizing program 101 optimizes search results based on additional search criteria entered by the user. In an embodiment, search result optimizing program 101 generates a list of one or more search results based, at least in part, on the additional search criteria. In an embodiment, search result optimizing program 101 evaluates the semantics of the initial search query and the search query results. In an embodiment, search result optimizing program 101 determines the key points from the idea or arguments presented in the initial search query and identifies relationships, keywords, or topics from the idea or arguments. In an embodiment, search result optimizing program 101 categorizes the relationships, keywords, or topics associated with the search results and suggests new search themes based on these knowledge areas. In an embodiment, search result optimizing program 101 filters search results based on the search themes and knowledge areas associated with prior search queries of a particular user.

In an embodiment, search result optimizing program 101 receives user input. In an embodiment, the user input is the initial search query. For example, if the user enters “computer virus software program for sale” on application 114, the user input is “computer virus software program for sale.” In an embodiment, in addition to a search query, search result optimizing program 101 receives additional search criteria from the user, such as a search type. A search type determines the type of search result the user is intending to receive. For example, a search type may be “general search,” “academic articles,” “research papers,” or “patents.”

In an embodiment, search result optimizing program 101 prompts the user to enter additional search criteria, such as particular search types that are relevant to the user's search query. For example, search result optimizing program 101 determines one or more search types from the user input and prompts the user to identify one or more search types relevant to the users search. In an embodiment, the additional search criteria include one or more knowledge areas of interest to the user. In an embodiment, search result optimizing program 101 determines the one or more knowledge areas of interest to the user based on historical search data associated with the user. In an embodiment, the knowledge area is the result type. In an embodiment, a knowledge area is an area or industry of interest. For example, a user input of “security mask” may generate search results from many different areas or industries such as “surgical mask,” “chemical mask,” or “Halloween mask.” In this example, search results optimizing program 101 requests for the user to input which area or industry they want search results from. In an embodiment, search result optimizing program 101 prompts the user to indicate one or more knowledge areas of interest. In an embodiment, search result optimizing program 101 determines and assigns a weight for each knowledge area of interest indicated by the user. In an embodiment, search result optimizing program 101 prompts the user to indicate an infinitive verb. An infinitive verb can be an additional filter to include if the user wants to buy, see, create, etc. from the search results. In an embodiment, search result optimizing program 101 determines one or more synonyms from the user input. In an embodiment, search result optimizing program 101 prompts the user to input one or more synonyms. In an embodiment, search result optimizing program 101 determines and assigns a weight for each synonym entered or selected by the user.

In an embodiment, search result optimizing program 101 retrieves an initial set of search results based, at least in part, on the search query and the additional user search input, including, but not limited to, the one or more knowledge areas of interest, the desired result types, and synonyms. In an embodiment, search result optimizing program 101 filters the initial set of search results. In an embodiment, filtering the initial set of search results includes removing advertisements from the initial search results. For example, if a search result is tagged or labeled as “AD” or “Advertisement”, search result optimizing program 101 removes the advertisements from the search results. In an embodiment, filtering the initial set of search results includes normalizing the initial search results data. In an embodiment, filtering the initial set of search results includes removing search results with broken links or duplicate search results from the same website or webpage. In an embodiment, search result optimizing program 101 removes duplicate links or search results. In an embodiment, search result optimizing program 101 determines the word count for each search result. For example, if a search result has 6,845 words, search result optimizing program 101 determines the word count for the search result is 6,845. In an embodiment, search result optimizing program 101 determines the word count for each abstract associated with a search result. In an embodiment, search result optimizing program 101 determines the word count for an attachment to the search result. In an embodiment, search result optimizing program 101 performs sentiment analysis on the search results. For example, search result optimizing program 101 utilizes natural language processing (NLP) and sentiment analysis to determine a sentiment associated with a search result. In an embodiment, sentiment analysis includes determining whether the search result has a positive, negative, happy, sad, etc. connotation.

In an embodiment, search result optimizing program 101 compares one or more features of a search result to one or more features included in the additional search criteria. In an embodiment, search result optimizing program 101 determines a matching search and result type. For example, search result optimizing program 101 determines if one or more search results match the knowledge area of the search. For example, if the knowledge area is determined to be “computer virus” and a search result pertains to “the human flu virus”, this search result would not match the knowledge area. In an embodiment, search result optimizing program 101 analyzes the word count of a search result. In an embodiment, search result optimizing program 101 assigns a weight to the word count. In an embodiment, search result optimizing program 101 determines the number of occurrences that words included in the search query or additional search information match words included in a search result. In an embodiment, search result optimizing program 101 determines the number of occurrences that words associated with a particular knowledge area of interest entered by the user match words included in a search result. In an embodiment, search result optimizing program 101 determines the number of occurrences that synonyms of a word included in the user search query or knowledge area of interest entered by the user match a word included in a search result. In an embodiment, search result optimizing program 101 analyzes the sentiment of a search result. In an embodiment, search result optimizing program 101 determines the relevancy of a search result based on the weight for each attribute, such as knowledge area, search type, synonyms, word count, or sentiment analysis. In an embodiment, search result optimizing program 101 ranks the search results based on their total weight for as knowledge area, search type, synonyms, word count, or sentiment analysis. In an embodiment, search result optimizing program 101 ranks the search results based on their weight for one or more attributes. In an embodiment, search result optimizing program 101 alters the previously assigned weight based on user feedback. In an embodiment, search result optimizing program 101 summarizes and justifies the rankings. For example, search result optimizing program 101 summarizes results with one or more portions of the search result with the most usage of a word from the user input. In an embodiment, search result optimizing program 101 determines if a search result is satisfactory for the users input query by analyzing one or more of the knowledge area, search type, synonyms, word count, sentiment analysis, their respective weights, summary, and justifications. In an embodiment, search result optimizing program 101 justifies the ranking by giving a reason why the search result was ranked high or low, or at a particular position within a ranked list of search results. For example, based on the particular information the user indicated they were searching for, a search result may not match a knowledge area or has a number of words above a predetermined threshold.

In an embodiment, search result optimizing program 101 determines if the search results satisfy the users input query. In an embodiment, search result optimizing program 101 prompts the user to indicate if the search results are satisfactory. For example, search result optimizing program 101 generates a pop-up window on application 114 via user interface 112, wherein the pop-up window requests a user to indicate whether or not the search results displayed to the user are relevant to the user's query. In an embodiment, feedback data collected from the user is used to improve upon or “fine tune” the search query patterns used to construct keyword queries for future queries. In an embodiment, feedback data collected from the user can be further used by machine learning module 129 to train machine learning model 136. In an embodiment, based on the feedback data, machine learning module 129 adjusts (increases or decreases) respective weights assigned to various components of machine learning model 136, including but not limited to a word counting component, argument match component, sentiment analysis component, and knowledge area component. Similarly, feedback data can be used to learn the particular weights that should be automatically selected and assigned to the aforementioned components of machine learning model 136 for use with similar future queries. For example, the weighted values assigned to the particular components of machine learning model 136 that achieved the optimal number of search results (a highest number of results that answer a query) or most relevant search result (the result that contained the most relevant information associated with a query) for past similar queries are automatically selected for retrieving results for similar future generated queries. In doing so, the top listed search results returned for a query are likely to be most relevant to answering the query the first time around without requiring the user to alter the search query itself in order to obtain the most relevant information associated with the user's query.

In an embodiment, if the user indicates the search results are not satisfactory, search result optimizing program 101 requests additional information from the user to update machine learning model 136 in order to refine future search results returned to the user. In an embodiment, if the user indicates the search results are satisfactory, search result optimizing program 101 stores search results 132 and user feedback 134 in user search profile database 131. In an embodiment, search result optimizing program 101 updates machine learning module 129 based on search results 132 and user feedback 134.

FIG. 2 is a flow chart diagram depicting operational steps for filtering the search query, generally designated 200, in accordance with at least one embodiment of the present invention. FIG. 2 provides only an illustration of one implementation and does not imply any limitations with regard to the environments in which different embodiments may be implemented. Many modifications to the depicted environment may be made by those skilled in the art without departing from the scope of the invention as recited by the claims.

At step S202, search result optimizing program 101 receives user input from a user. In an embodiment, the user input is a search query. In an embodiment, the user input further includes additional search criteria.

At step S204, search result optimizing program 101 receives a search type from the user. In an embodiment, the search type is the type of search result the user is intending to receive. In an embodiment, search result optimizing program 101 prompts the user for the search type via application 114 located on user device 110. For example, a search type includes the type of search results desired such as articles, a store, products, patents, etc.

At step S206, search result optimizing program 101 receives information associated with one or more result types from the user. In an embodiment, the result type is a parameter associated with a search result. For example, the result type may be search results associated with a particular knowledge area. In an embodiment, the result type may be search results associated with a particular area or industry of interest.

At step S208, search result optimizing program 101 determines one or more synonyms for consideration by the user. In an embodiment, the one or more synonyms are implemented as part of the user generated search query. In an embodiment, the one or more synonyms are utilized when returning search results to the user. In an embodiment, search result optimizing program 101 prompts the user to enter one or more valid synonyms via application 114. In an embodiment, search result optimizing program 101 automatically generates one or more synonyms associated with words included in a user generated search query and presents the synonyms via application 114 for selection by the user selects.

At step S210, search result optimizing program 101 generates a search query pattern. In an embodiment, search result optimizing program 101 generates a search query pattern based on the search query input. In an embodiment, the search query pattern is further generated based, at least in part, on the additional search criteria. In an embodiment, search result optimizing program 101 updates the search query pattern based on one or more synonyms of words included in the search query input and/or the additional search criteria. In an embodiment, search result optimizing program 101 generates a search query based on information associated with one or more result types from the user.

At step S212, search result optimizing program 101 returns one or more search results based on the generated search query pattern. In an embodiment, search result optimizing program 101 stores the search results in storage device 130.

FIG. 3 is a flow chart diagram depicting operational steps for updating an initial set of search results, generally designated 300, in accordance with at least one embodiment of the present invention. FIG. 3 provides only an illustration of one implementation and does not imply any limitations with regard to the environments in which different embodiments may be implemented. Many modifications to the depicted environment may be made by those skilled in the art without departing from the scope of the invention as recited by the claims.

At step S302, search result optimizing program 101 retrieves an initial set of search results returned from step S212 of FIG. 2. In an embodiment, search result optimizing program 101 retrieves the initial set of search results from storage device 130.

At step S304, search result optimizing program 101 filters the initial set of search results by removing advertisements from the initial set of search results. In an embodiment, search result optimizing program 101 removes any search results associated with an advertisement. In an embodiment, search result optimizing program 101 filters the initial set of search results by removing any search results that contain links, URLs, documents, images, or otherwise labeled as “advertisement” or “AD.”

At step S306, search result optimizing program 101 filters the initial set of search results by normalizing the initial set of search results. In an embodiment, normalizing the initial set of search results includes removing search results with broken links or duplicate search results associated with the same website or webpage.

At step S308, search result optimizing program 101 determines the number of constant word occurrences. For example, search result optimizing program 101 determines how many times a word is mentioned or used in a given document, website, or webpage.

At step S310, search result optimizing program 101 filters the initial set of search results based on performing sentiment analysis on the initial set of search results. In an embodiment, search result optimizing program 101 determines a sentiment associated with a search result. In an embodiment, sentiment analysis includes determining whether the search result has a positive, negative, happy, sad, etc. connotation.

At step S312 search result optimizing program 101 updates the initial set of search results based on the operations performed in steps S304-S308. In an embodiment, search result optimizing program 101 stores the updated set of search results in storage device 130.

FIG. 4 is a flow chart diagram depicting operational steps for generating a final set of search results, generally designated 400, in accordance with at least one embodiment of the present invention. FIG. 4 provides only an illustration of one implementation and does not imply any limitations with regard to the environments in which different embodiments may be implemented. Many modifications to the depicted environment may be made by those skilled in the art without departing from the scope of the invention as recited by the claims.

At step S402, search result optimizing program 101 retrieves the updated set of search results generated in accordance with the flowchart steps of FIG. 3. In an embodiment, search result optimizing program 101 retrieves the updated set of search results from storage device 130.

At step S404, search result optimizing program 101 determines the matching search and result type. In an embodiment, a search type determines the type of search result the user is intending to receive. In an embodiment, a result type is an area or industry of interest. In an embodiment, search result optimizing program 101 prompts the user to enter one or more search types or result types that are relevant to the user's search query.

At step S406, search result optimizing program 101 analyzes the word count of a search result. In an embodiment, search result optimizing program 101 analyzes the word count of the entire link, webpage or website associated with a URL, or abstract. In an embodiment, analyzing the word count includes comparing the word count to a threshold word limit indicated by the user. For example, a user indicates a predetermined threshold of number of words for an abstract, such as 500 words maximum.

At step S408, search result optimizing program 101 analyzes the sentiment of a search result. In an embodiment, analyzing the sentiment of a search result includes comparing the sentiment to one or more preferred sentiments indicated by the user. For example, a user indicates they desire the search results to contain a certain type of sentiment. In this example, search result optimizing program 101 compares the desired type of sentiment to the sentiment of the search result to determine if the search result has the same or relevant sentiment.

At step S410, search result optimizing program 101 ranks the updated set of search results. In an embodiment, search result optimizing program 101 ranks the updated set of search results based on their assigned weight. In an embodiment, search result optimizing program 101 ranks the updated set of search results based on a degree of relevancy with respect to one or more factors associated with the additional search criteria.

At step S412, search result optimizing program 101 summarizes and justifies the rankings.

At step S414, search result optimizing program 101 generates and displays the final set of ranked search results. In an embodiment, search result optimizing program 101 displays the final set of ranked search results via user interface 122 of user device 110.

FIG. 5 is a flow chart diagram depicting operational steps for updating a machine learning model, generally designated 500, in accordance with at least one embodiment of the present invention. FIG. 5 provides only an illustration of one implementation and does not imply any limitations with regard to the environments in which different embodiments may be implemented. Many modifications to the depicted environment may be made by those skilled in the art without departing from the scope of the invention as recited by the claims.

At decision step S502, search result optimizing program 101 determines whether one or more search results are relevant to the user's search query. In an embodiment, search result optimizing program 101 determines which ranked search results are most relevant to the user's search query. In an embodiment, search result optimizing program 101 receives user feedback on the search results to determine which search results are relevant and/or which search results are the most relevant and least relevant. In an embodiment, search result optimizing program 101 prompts the user for user feedback on the search results. If at least one search result is not relevant to the user's query (decision step S502 “NO” branch), result optimizing program 101 proceeds to step S504. If it is determined that at least one search result is relevant to the user's query (decision step S502 “YES” branch), result optimizing program 101 proceeds to step S506.

At step S504, search result optimizing program 101 requests more information. In an embodiment, search result optimizing program 101 requests the user to indicate one or more different results type, search type, or synonyms than previously indicated.

At step S506, search result optimizing program 101 stores response data. In an embodiment, result optimizing program 101 stores response data in in user search profile database 131.

At step S508, search result optimizing program 101 updates the machine learning model. For example, search result optimizing program updates machine learning model 136 depicted in FIG. 1.

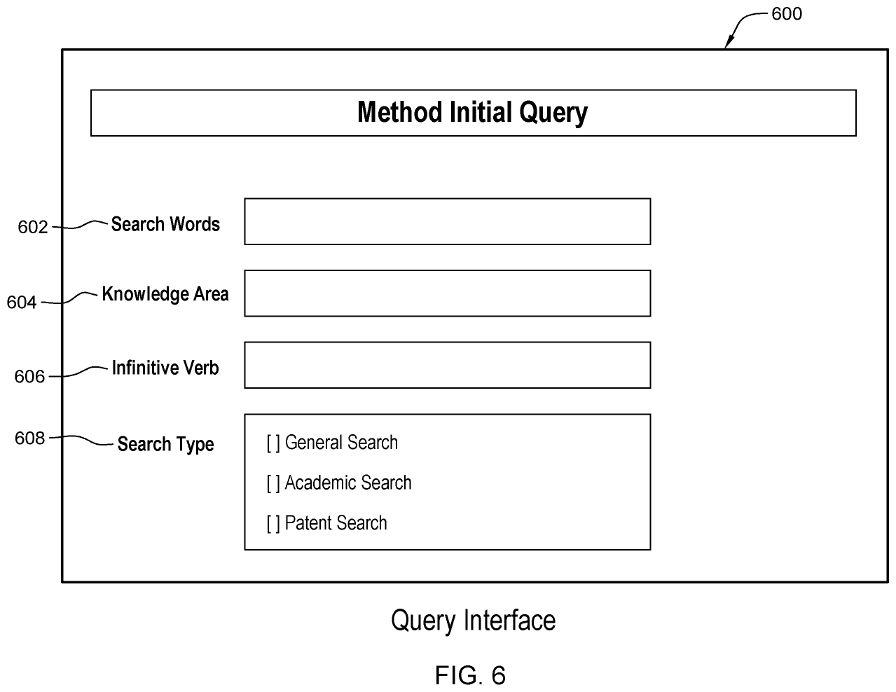

FIG. 6 illustrates an exemplary query interface 600 for entering a query and various additional information associated with the query, in accordance with at least one embodiment of the present invention. For example, FIG. 6 is illustrative of user interface 112 of application 114 running on user device 110. As depicted in FIG. 6, query interface 600 includes search words 602, knowledge area 604, infinitive verbs 606, and search type 608. In an embodiment, a user can input or select one or more search words 602, knowledge area 604, infinitive verbs 606, and search types 608 for use by search query optimizing program 101 to optimize the relevancy of search results returned to a user for a given query.

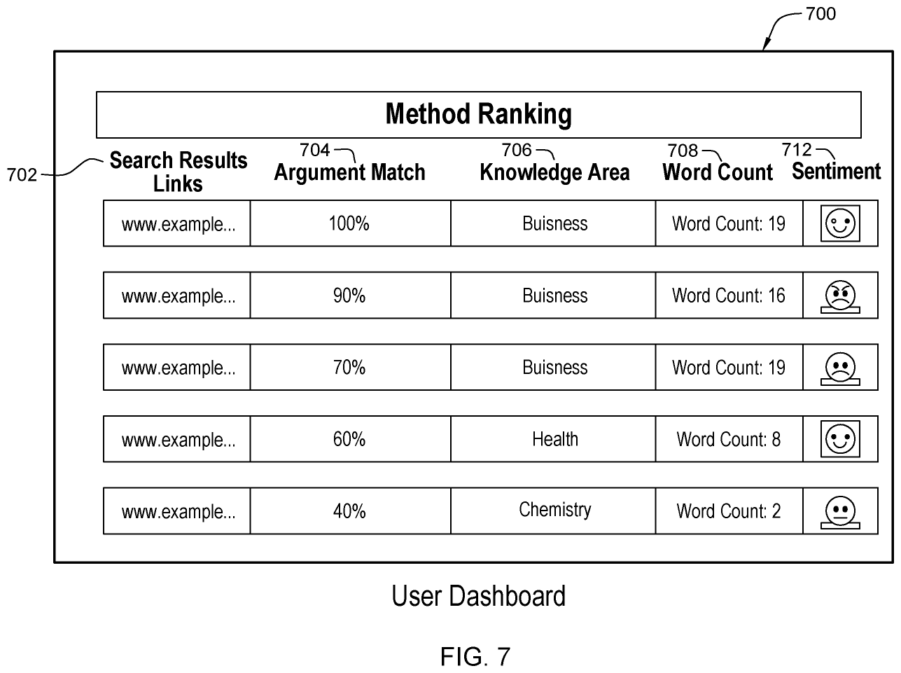

FIG. 7 illustrates an exemplary user dashboard 700 for displaying search results and various additional information associated with the search results, in accordance with at least one embodiment of the present invention. For example, FIG. 7 is illustrative of user interface 112 of application 114 running on user device 110. As depicted in FIG. 7, user dashboard 700 includes search result links 702, argument match 704, knowledge area 706, word count 708, and sentiment 712. In an embodiment, links 702 include one or more links to webpages or documents that are presented to a user in response to a user query. In an embodiment, argument match 704 includes a percentage or degree of relevancy of a particular link with respect to a user query. In an embodiment, knowledge area 706 includes or describes the knowledge area of the search result. In an embodiment, word count 708 indicates the word count or number of words in the search result. In an embodiment, sentiment 712 includes the sentiment associated with the link or webpage. For example, sentiment 712 includes words such as “happy” “sad” or “angry.” In another example, sentiment 712 includes a numerical degree of association between the sentiment of the link and the desired search result sentiment indicated by the user.

FIG. 8 is a block diagram depicting components of a computing device, generally designated 800, suitable for operation of search result optimizing program 101 in accordance with at least one embodiment of the invention. Computing device 800 includes one or more processor(s) 804 (including one or more computer processors), communications fabric 802, memory 806 including, RAM 816 and cache 818, persistent storage 808, which further includes search result optimizing program 101, which further includes initial query module 122, search results processing module 124, search ranking module 126, user dashboard module 128, and machine learning module 129, communications unit 812, I/O interface(s) 814, display 822, and external device(s) 820. It should be appreciated that FIG. 8 provides only an illustration of one embodiment and does not imply any limitations with regard to the environments in which different embodiments may be implemented. Many modifications to the depicted environment may be made.

As depicted, computing device 800 operates over communications fabric 802, which provides communications between computer processor(s) 804, memory 806, persistent storage 808, communications unit 812, and input/output (I/O) interface(s) 814. Communications fabric 802 can be implemented with any architecture suitable for passing data or control information between processor(s) 804 (e.g., microprocessors, communications processors, and network processors), memory 806, external device(s) 820, and any other hardware components within a system. For example, communications fabric 802 can be implemented with one or more buses.

Memory 806 and persistent storage 808 are computer readable storage media. In the depicted embodiment, memory 806 includes random-access memory (RAM) 816 and cache 818. In general, memory 806 can include any suitable volatile or non-volatile one or more computer readable storage media.

Program instructions for search result optimizing program 101 can be stored in persistent storage 808, or more generally, any computer readable storage media, for execution by one or more of the respective computer processor(s) 804 via one or more memories of memory 806. Persistent storage 808 can be a magnetic hard disk drive, a solid-state disk drive, a semiconductor storage device, read-only memory (ROM), electronically erasable programmable read-only memory (EEPROM), flash memory, or any other computer readable storage media that is capable of storing program instructions or digital information.

Media used by persistent storage 808 may also be removable. For example, a removable hard drive may be used for persistent storage 808. Other examples include optical and magnetic disks, thumb drives, and smart cards that are inserted into a drive for transfer onto another computer readable storage medium that is also part of persistent storage 808.

Communications unit 812, in these examples, provides for communications with other data processing systems or devices. In these examples, communications unit 812 can include one or more network interface cards. Communications unit 812 may provide communications through the use of either or both physical and wireless communications links. In the context of some embodiments of the present invention, the source of the various input data may be physically remote to computing device 800 such that the input data may be received, and the output similarly transmitted via communications unit 812.

I/O interface(s) 814 allows for input and output of data with other devices that may operate in conjunction with computing device 800. For example, I/O interface(s) 814 may provide a connection to external device(s) 820, which may be as a keyboard, keypad, a touch screen, or other suitable input devices. External device(s) 820 can also include portable computer readable storage media, for example thumb drives, portable optical or magnetic disks, and memory cards. Software and data used to practice embodiments of the present invention can be stored on such portable computer readable storage media and may be loaded onto persistent storage 808 via I/O interface(s) 814. I/O interface(s) 814 also can similarly connect to display 822. Display 822 provides a mechanism to display data to a user and may be, for example, a computer monitor.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

FIG. 9 is a block diagram depicting a cloud computing environment 50 in accordance with at least one embodiment of the present invention. Cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

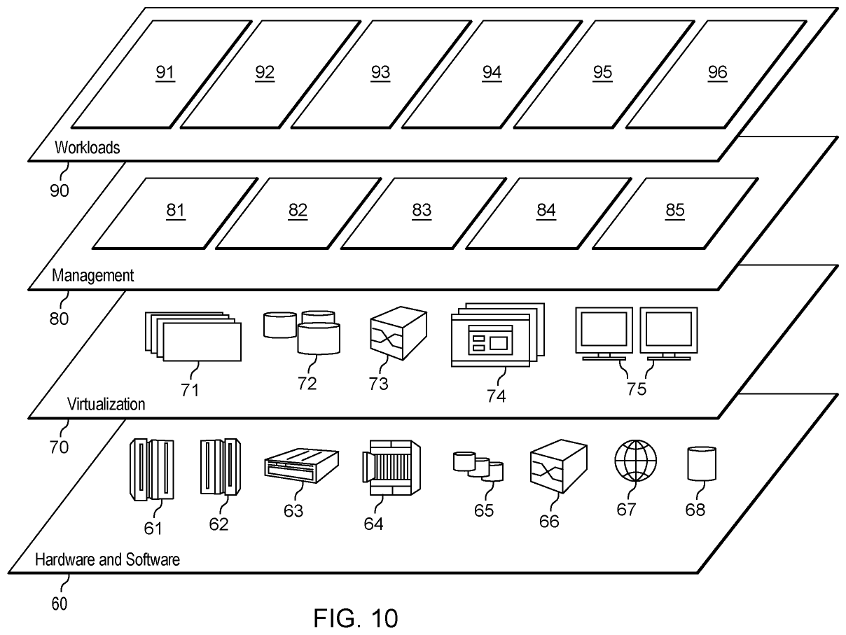

FIG. 10 is block diagram depicting a set of functional abstraction model layers provided by cloud computing environment 50 depicted in FIG. 9 in accordance with at least one embodiment of the present invention. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and search result optimization 96.

What is claimed is:

1. A computer-implemented method for generating optimized search results, the computer-implemented method comprising:
receiving a search input from a user, wherein the search input includes a search query and additional search criteria;
generating a search query pattern based, at least in part, on the search input;
determining an initial set of search results based on the search query pattern; and
filtering the initial set of search results to determine a filtered subset of search results from the initial set of search results.

2. The computer-implemented method of claim 1, wherein the additional search criteria includes one or more knowledge areas, one or more search types, one or more synonyms of words included in the search query, one or more infinitive verbs, a maximum word count of an abstract corresponding to a search result, and one or more sentiments associated with a search result.

3. The computer-implemented method of claim 2, further comprising:
automatically determining the one or more synonyms of the words included in the search query.

4. The computer-implemented method of claim 2, further comprising:
updating the first search query pattern based, at least in part, on the one or more synonyms automatically determined from the words included in the search query.

5. The computer-implemented method of claim 1, wherein filtering the initial set of search results further includes:
normalizing the initial set of search results, wherein normalizing the initial set of search results includes removing search results with broken links or duplicate search results associates with a common website or webpage; and
removing any advertisements from a search results page and any links associated with an advertisement.

6. The computer-implemented method of claim 1, further comprising:
ranking the filtered subset of search results, wherein the filtered subset of search results are ranked based, at least in part, on a weighted set of factors associated with a machine learning model.

7. The computer-implemented method of claim 6, further comprising:
updating a weight assigned to one or more factors associated with the machine learning model based, at least in part, on user feedback; and
re-ranking the filtered subset of search results based on updating the weight assigned to one or more factors associated with the machine learning model.

8. A computer program product for generating optimized search results, the computer program product comprising one or more computer readable storage media and program instructions stored on the one or more computer readable storage media, the program instructions including instructions to:
receive a search input from a user, wherein the search input includes a search query and additional search criteria;
generate a search query pattern based, at least in part, on the search input;
determine an initial set of search results based on the search query pattern; and
filter the initial set of search results to determine a filtered subset of search results from the initial set of search results.

9. The computer program product of claim 8, wherein the additional search criteria includes one or more knowledge areas, one or more search types, one or more synonyms of words included in the search query, one or more infinitive verbs, a maximum word count of an abstract corresponding to a search result, and one or more sentiments associated with a search result.

10. The computer program product of claim 9, further comprising instructions to:
automatically determine the one or more synonyms of the words included in the search query.

11. The computer program product of claim 9, further comprising instructions to:
update the first search query pattern based, at least in part, on the one or more synonyms automatically determined from the words included in the search query.

12. The computer program product of claim 8, wherein the instructions to filter the initial set of search results further includes instructions to:
normalize the initial set of search results, wherein normalizing the initial set of search results includes removing search results with broken links or duplicate search results associates with a common website or webpage; and
remove any advertisements from a search results page and any links associated with an advertisement.

13. The computer program product of claim 8, further comprising instructions to:
rank the filtered subset of search results, wherein the filtered subset of search results are ranked based, at least in part, on a weighted set of factors associated with a machine learning model.

14. The computer program product of claim 13, further comprising instructions to:
update a weight assigned to one or more factors associated with the machine learning model based, at least in part, on user feedback; and
re-ranking the filtered subset of search results based on updating the weight assigned to one or more factors associated with the machine learning model.

15. A computer system for generating optimized search results, comprising:
one or more computer processors;
one or more computer readable storage media; and
computer program instructions, the computer program instructions being stored on the one or more computer readable storage media for execution by the one or more computer processors, the computer program instructions including instructions to:
receive a search input from a user, wherein the search input includes a search query and additional search criteria;
generate a search query pattern based, at least in part, on the search input;
determine an initial set of search results based on the search query pattern; and
filter the initial set of search results to determine a filtered subset of search results from the initial set of search results.

16. The computer system of claim 15, wherein the additional search criteria includes one or more knowledge areas, one or more search types, one or more synonyms of words included in the search query, one or more infinitive verbs, a maximum word count of an abstract corresponding to a search result, and one or more sentiments associated with a search result.

17. The computer system of claim 16, further comprising instructions to:
automatically determine the one or more synonyms of the words included in the search query.

18. The computer system of claim 16, further comprising instructions to:
update the first search query pattern based, at least in part, on the one or more synonyms automatically determined from the words included in the search query.

19. The computer system of claim 15, wherein the instructions to filter the initial set of search results further includes instructions to:
normalize the initial set of search results, wherein normalizing the initial set of search results includes removing search results with broken links or duplicate search results associates with a common website or webpage; and
remove any advertisements from a search results page and any links associated with an advertisement.

20. The computer system of claim 15, further comprising instructions to:
rank the filtered subset of search results, wherein the filtered subset of search results are ranked based, at least in part, on a weighted set of factors associated with a machine learning model.
